(19) United States
(12) Patent Application Publication
(10) Pub. No.: US 2021/0125435 A1
(43) Pub. Date: Apr. 29, 2021

(54) Drone Delivery Locker

(71) Applicant: Daniel Tagliaferri, Alameda, CA (US)

(72) Inventor: Daniel Tagliaferri, Alameda, CA (US)

(21) Appl. No.: 17/080,346

(22) Filed: Oct. 26, 2020

Related U.S. Application Data
(60) Provisional application No. 62/926,442, filed on Oct. 26, 2019.

(51) Int. Cl. G07C 9/00; G06Q 10/08

(52) U.S. Cl. CPC G07C 9/00182; G06Q 10/083

(57) ABSTRACT

A drone delivery locker is disclosed. In an embodiment, a drone delivery locker includes a locker cabinet, a drone delivery access door on the locker cabinet, and a controller that opens the drone delivery access door upon receiving a transmission from a drone that includes a secure access code.

### CROSS REFERENCE TO RELATED APPLICATIONS

This application claims the benefit of priority under U.S.C. 119 from U.S. Provisional Application No. 62/926,442 filed on Oct. 26, 2019 and entitled “Drone Delivery Locker,” which is herein incorporated by reference in its entirety.

### TECHNICAL FIELD

The present invention relates generally to delivery and receiving systems, and more particularly, to a drone delivery locker for receiving drone package deliveries.

### BACKGROUND

Online shopping has resulted in an increase in package deliveries using available ground carriers. The use of drones (e.g., an unpiloted aircraft or spacecraft or an “unmanned aerial vehicle” (UAV)) to make package deliveries would improve delivery times and reduce traffic congestion.

Unfortunately, very few locations are set up to receive drone deliveries. For example, individuals or corporations ordering products online may not have a secure way to receive a drone delivery.

### SUMMARY

In various embodiments, a drone delivery locker is provided that automatically accepts package deliveries from drones and provides package security until the packages are retrieved.

In an embodiment, a drone delivery locker is provided that includes a locker cabinet, a drone delivery access door on the locker cabinet, and a controller that opens the drone delivery access door upon receiving a transmission from a drone that includes a secure access code.

In an embodiment, a method is provided for operating a drone delivery locker. The method comprises receiving a secure code that indicates that a package is to be delivered by a drone, opening an access door on the locker to allow the package to be delivered by the drone, securing the access door upon receipt of a lock code from the drone, sending a notification to a user that a package has been delivered.

In an embodiment, a method is provided for operating a drone. The method comprises configuring the drone to carry a package, programming the drone with a location and secure access code of a delivery locker, flying the drone to the location to find the delivery locker, utilizing alignment features to align the drone with the delivery locker, transmitting the secure code from the drone to open a door of the delivery locker, delivering the package from the drone into the delivery locker through the door, and transmitting a lock code from the drone to close the door of the delivery locker to secure the package.

The foregoing is a summary and thus contains, by necessity, simplifications, generalizations and omissions of detail; consequently it is appreciated that the summary is illustrative only. Still other methods, and structures and details are set forth in the detailed description below.

### BRIEF DESCRIPTION OF THE DRAWINGS

The accompanying drawings, where like numerals indicate like components, illustrate embodiments of the invention.

FIG. 1 illustrates a drone delivery system that includes an exemplary embodiment of a drone delivery locker.

FIG. 2 illustrates how the drone delivery system shown in FIG. 1 operates to delivery packages to a plurality of drone delivery lockers each having a unique secure access code.

FIG. 3 shows an exemplary detailed embodiment of a drone delivery locker and illustrates operations performed for secure package delivery.

FIG. 4 shows an exemplary method for operating an embodiment of a drone delivery locker.

FIG. 5 shows an exemplary method for delivering packages to a plurality of drone delivery lockers.

### DETAILED DESCRIPTION

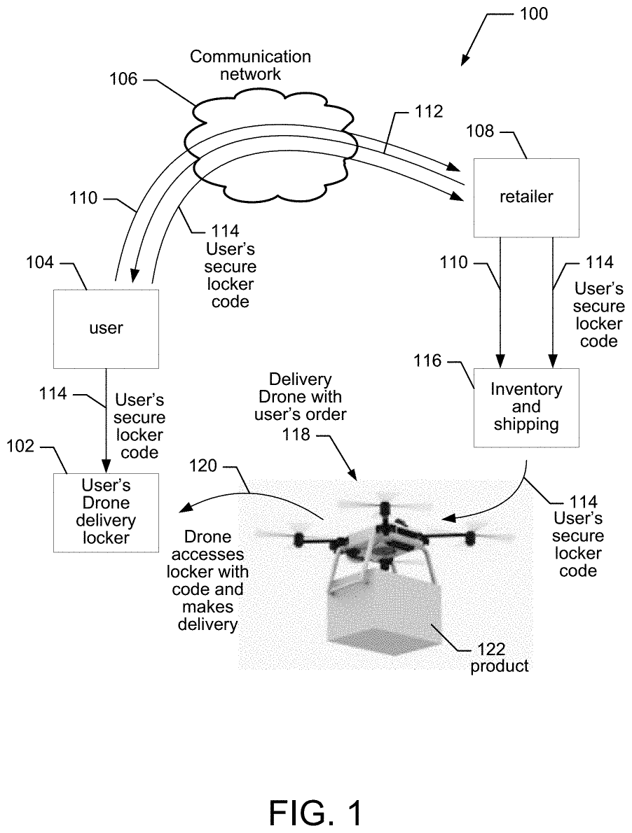

FIG. 1 illustrates a drone delivery system 100 that includes an exemplary embodiment of a drone delivery locker 102. A user 104 communicates with a retailer 108 using communication network 106. The user can be an individual or corporation. The user 104 places an order 110 for a product with the retailer 108. The retailer 108 transmits an order acceptance 112 and requests information about the user's delivery locker 102. The information includes locker location information and the user's secure locker code. The user 104 responds by transmitting a secure locker code 114 and additional information about the location, size, and other capabilities of the delivery locker 102. The user 102 also programs the delivery locker 102 to provide access when the secure locker code 114 is received. The secure locker code 114 is programmable and changeable so that new codes can be used for each delivery. The codes may also be set to expire after a selected time interval and multiple different codes can be programmed for multiple deliveries.

The retailer 108 communicates with an inventory and shipping center 116 to arrange for the product to be delivered to the user's locker 102 via a drone. The retailer 108 sends the product order 110 and the secure locker code 114 including the locker location and any other information to the inventory and shipping center 116.

The inventory and shipping center 116 prepares drone 118 to deliver the product 122 ordered by the user. The inventory and shipping center 116 provides the secure locker code 114 to the drone as well as location information of the user's delivery locker 102.

The drone 118 flies to the location of the user's delivery locker 102 and positions itself to deliver the product 122 to the locker 102. The drone 118 transmits (indicated at 120) the secure locker code 114 to access the delivery locker 102. In response to receiving the secure locker code 114, the delivery locker 102 provides access to the drone 118. Once access is provided, the drone 118 delivers the product 122 into the locker and transmits an exit code that causes the delivery locker 102 to secure the product. For example, when the secure locker code 114 is received, the locker 102 opens a delivery access door to allow the drone to deliver the product 122 into the locker. The drone then returns to the inventory and shipping center 116 to be prepared to make another delivery. The product 122 is secured in the delivery locker 102 until the user opens the locker to retrieve the product.

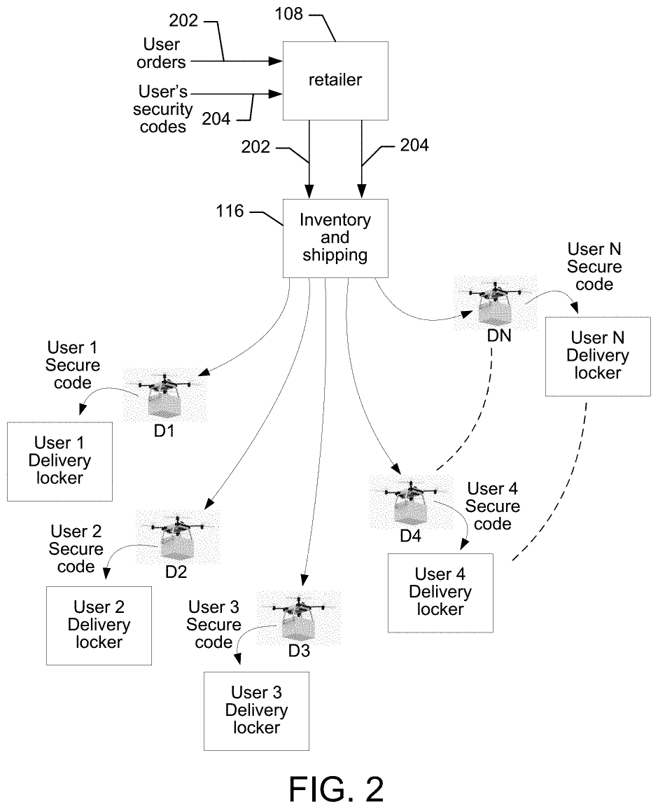

FIG. 2 illustrates how the drone delivery system shown in FIG. 1 operates to deliver packages to a plurality of drone delivery lockers each having a unique secure access code. The retailer 108 receives a plurality of user orders 202 for products sold by the retailer. Each order is associated with a secure locker having an identified location and secure code. Thus, the plurality of orders 202 are associated with a plurality of secure locker codes 204, respectively.

The retailer 108 provides the orders 202 and associated locker codes 204 with locker locations to the inventory and shipping center 116. A plurality of drones (D1-D_{N}) are prepared to deliver the orders to the delivery lockers. For example, drone (D1) delivers to the delivery locker of user 1, D2 delivers to the delivery locker of user 2, and so on, such that drone D_{N} delivers to the delivery locker of user N.

Each drone is provided with the access code and location associated with the locker to which the delivery is to be made. Thus, as each drone arrives at its assigned locker location, each drone transmits the appropriate locker code to access the locker to make its delivery. After deliveries are made, the drones return to the inventory and shipping center 116 to be prepared to make more deliveries. Thus, the drones may make hundreds or thousands of secure deliveries in a single day. Each delivered package is secured within the corresponding delivery locker until the owner opens the locker to retrieve the package.

In an embodiment, the drones are configured to make multiple deliveries in a single trip. For example, a drone is prepared to deliver two packages and is provided with the locations and access codes for two delivery lockers. The drone includes a mechanism to selectively deliver each package. The drone flies to the first locker and makes the first delivery using the first access code. The drone then flies to the second location and makes the second delivery using the second access code.

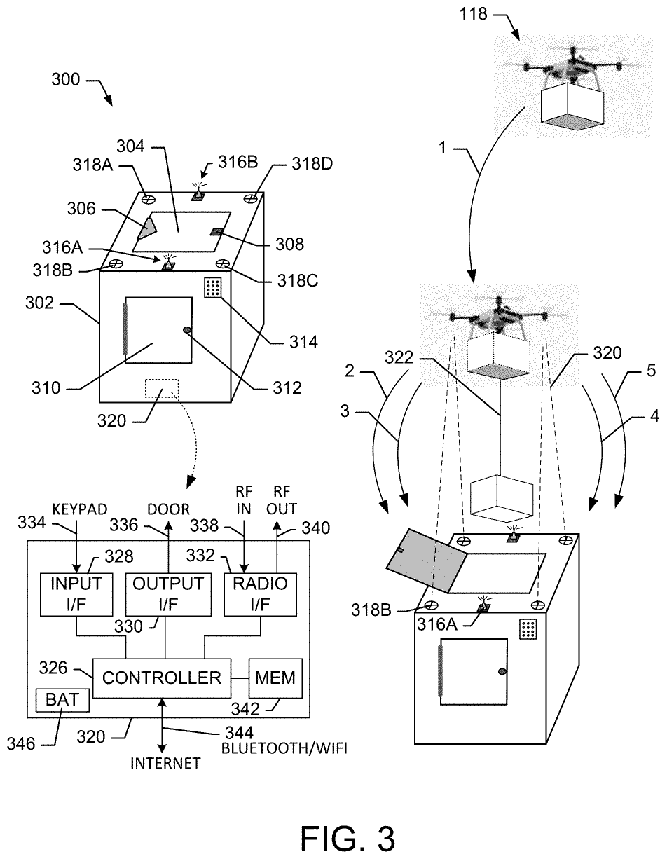

FIG. 3 shows an exemplary detailed embodiment of a drone delivery locker 300 and illustrates operations performed for secure package delivery. For example, the locker 300 is suitable for use as the locker 102 shown in FIG. 1. In an embodiment, the locker 300 comprise a locker container 302 having a delivery door 304, operable door hinge 306, door lock 308, and access door 310 having an access lock 312. The locker 300 also comprises a keypad 314, antennas 316A-B, alignment features 318A-D, and control unit 320. The locker 300 also comprises a battery 346 to provide power during stand-alone operation. The locker can also be directly connected to electrical power.

In an embodiment, the control unit 320 comprises controller 326, input interface 328, output interface 330, radio interface 332, and memory 342. In an embodiment, the input interface 328 receives keypad input 334 from the keypad 314. The output interface 330 outputs door control signals 336 to the operable door hinge 306. The radio interface 332 transmits control signals 338 and receives access signals 340 to/from deliverer drones. The controller 326 also communicates over the Internet using Bluetooth or WiFi connection 344.

During operation, the following actions are performed.

1. drone 118 locates secure locker 300 of user using preprogramed location information.
2. drone 118 aligns with secure locker 300 using alignment features 318A-D.
3. drone transmits secure code to open locker door.
4. drone delivers package into locker using guide wire 322 or other delivery mechanism.
5. drone transmits lock code to secure locker door.

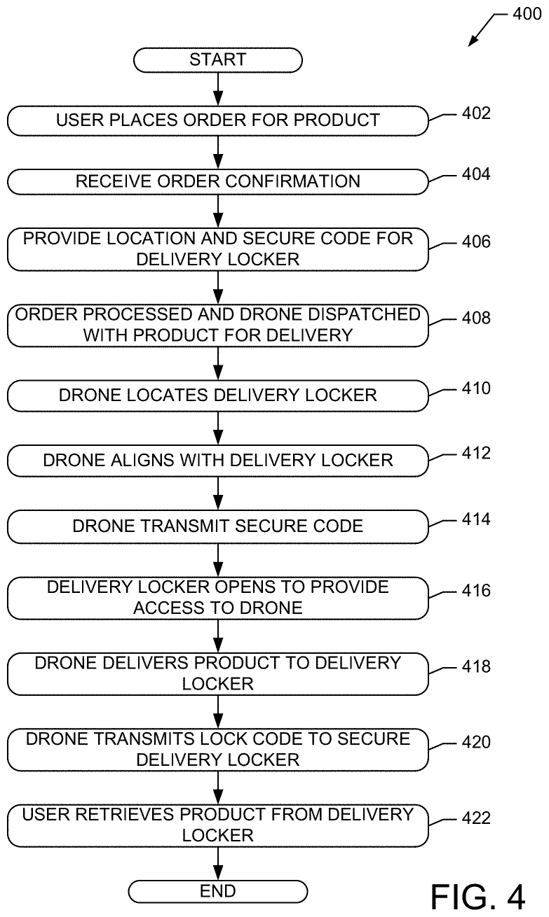

FIG. 4 shows an exemplary method 400 for operating an embodiment of a drone delivery locker. For example, the method 400 is suitable for use with the drone delivery locker 102 shown in FIG. 1 and the drone delivery locker 300 shown in FIG. 3.

At block 402, a user places an order for a product. For example, the user orders the product from an online retailer.

At block 404, an order confirmation is received. For example, the online retailer sends a confirmation of the order to the user.

At block 406, user provides the location and secure code for the user's delivery locker.

At block 408, the order is processed and a delivery drone is dispatched with the product for delivery to the user's delivery locker. For example, the drone is programmed with the locker location and secure access code.

At block 410, the drone locates the delivery locker.

At block 412, the drone aligns with the access door of the delivery locker. For example, the drone includes a camera system that uses the alignment features 318A-D to align the drone with the delivery locker.

At block 414, the drone transmits the secure code to the delivery locker. In another embodiment, the drone communicates with the retailer to indicate it is ready to make the delivery and the retailer transmits the secure access code to the delivery locker. The transmission may be over-the-air or over the Internet.

At block 416, in response to receiving the secure code, the delivery locker provides access to the drone by opening the secure door 304. For example, the controller 326 controls the output interface 330 to output door control signals 336 to the operable door hinge 306 to open the door 304 of the delivery locker 300.

At block 418, the drone delivers the product to the delivery locker. For example, the drone uses guide wire 322 to lower the package through the open door and into the delivery locker 300.

At block 420, the drone transmits a lock code to secure the product in the delivery locker. For example, the drone transmits the lock code that is received by the controller 326, which in response, outputs door control signals 336 to secure the access door 304. In another embodiment, the drone communicates with the retailer to indicate it is ready secure the locker and the retailer transmits the lock code to lock the delivery locker. The transmission may be over-the-air or over the Internet.

At block 422, the user retrieves the product from the secure delivery locker. In an embodiment, the controller transmits status information to the user over the Internet to alert the user of the delivery. For example, the user is notified of the delivery, either by the locker or the retailer. The user then retrieves the package through the access door 310.

Thus, the method 400 operates an embodiment of a drone delivery locker to receive a delivery from a drone. It should be noted that the operation of the method 400 can be changed, deleted, added to, rearranged, or otherwise modified within the scope of the embodiments.

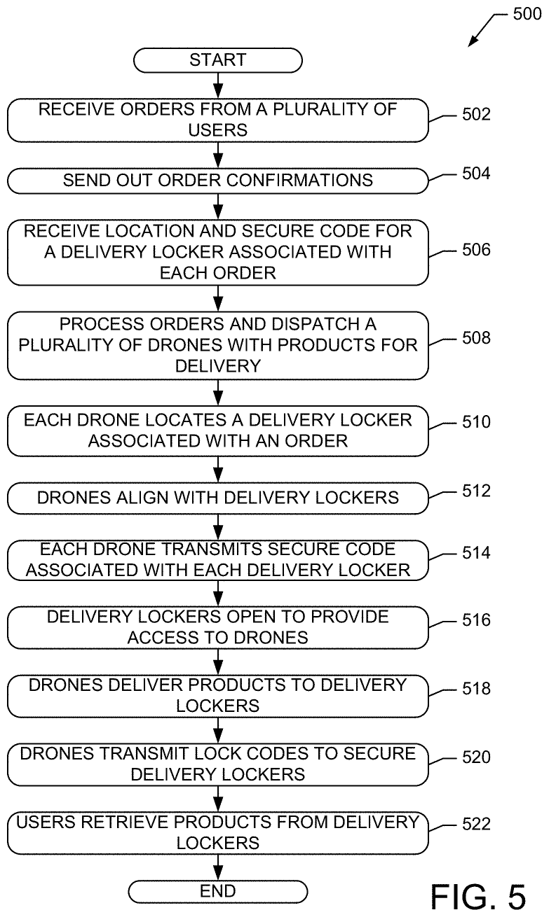

FIG. 5 shows an exemplary method 500 for delivering packages to a plurality of drone delivery lockers.

At block 502, a plurality of orders are received at a retailer from a plurality of users. For example, the orders may be received over the Internet.

At block 504, order confirmations are sent out. For example, a confirmation is sent out from the retail to each user who has placed an order.

At block 506, the retailer receives the location and secure code for each delivery locker from the users placing the orders.

At block 508, the orders are processed and a plurality of delivery drone are dispatched with the products for delivery to the users' delivery lockers. Each drone is programmed with the location and secure code for the locker to which it is to make a delivery.

At block 510, each drone locates the delivery locker associated with the order that it is to deliver.

At block 512, each drone aligns with the access door of the delivery locker associated with the order it is to deliver.

At block 514, each drone transmits the secure code associated with the order it is to deliver. In one embodiment, the transmission is made from the drone itself. In another embodiment, the transmission is over the Internet. For example, the retailer transmits the secure code over the Internet and the controller 326 receives the transmission using its WiFi connection 344. Any type of transmission can be used to transmit the secure code to a particular locker.

At block 516, in response to receiving a secure code, each delivery locker provides access to allow a drone to make a delivery.

At block 518, each drone delivers its product in the respective delivery locker.

At block 520, each drone transmits a lock code to secure the product in the respective delivery locker. In another embodiment, the lock code is send via Internet or other transmission type.

At block 522, each user retrieves the ordered product from the user's secure delivery locker. In an embodiment, each user is notified after the drone delivery is made. In one embodiment, the locker notifies the user. In another embodiment, the retailer notifies the user.

Thus, the method 500 operates to deliver packages to a plurality of drone delivery lockers. It should be noted that the operation of the method 400 can be changed, deleted, added to, rearranged, or otherwise modified within the scope of the embodiments.

### Alternate Embodiments and Enhancements

Additional embodiments and enhancements are available for use with the drone delivery locker.

In one embodiment, the locker 300 can receive and store multiple access codes. For example, the codes can be stored in the memory 342. Thus, multiple deliveries can be received and each delivery drone uses its own (or separate) access code to delivery its package to the locker. In another embodiment, the drone does not communication with the locker and the communication with the locker is done over the Internet.

In one embodiment, the locker 300 is large enough to allow a drone to lower a package into the locker through the door 304. In another embodiment, the door 304 is large enough to allow a drone to enter and/or land within the locker to make a delivery. In another embodiment, the locker 300 includes a padded or soft interior, such that a package may be dropped into the locker without sustaining any damage.

In one embodiment, the controller 326 of the locker 300 is connected to allow the information to be sent and received over the Internet. For example, user notifications can be sent to the locker owner when a package is delivered along with the access code that was used. The owner may also transmit instructions to the locker, such as changing the access code, adding more codes, or adjusting any other locker settings. In another embodiment, the locker can operate in stand-alone mode. In this mode the user communicates with the locker through the keypad 314 to enter the secure lock code. The locker then runs on battery power and waits to receive the secure code to receive a delivery.

Although certain specific embodiments are described above in order to illustrate the invention, the invention is not limited to the specific embodiments. Accordingly, various modifications, adaptations, and combinations of various features of the described embodiments can be practiced without departing from the scope of the invention as set forth in the claims.

What is claimed is:

1. An drone delivery locker comprising:
a locker cabinet;
a drone delivery access door on the locker cabinet; and
a controller that opens the drone delivery access door upon receiving a transmission from a drone that includes a secure access code.

2. The apparatus of claim 1, wherein the controller closes the access door upon receiving a transmission of a lock code.

3. The apparatus of claim 1, further comprises alignment features that allow the drone to align with the locker cabinet.

4. The apparatus of claim 1, wherein the controller is coupled to the Internet to receive the secure access code and the lock code.

5. The apparatus of claim 1, wherein the controller receives at least one of the secure access code and the lock code in a wireless transmission.

6. A method for operating a drone delivery locker comprising:
receiving a secure code that indicates that a package is to be delivered by a drone;
opening an access door on the locker to allow the package to be delivered by the drone;
securing the access door upon receipt of a lock code from the drone;
sending a notification to a user that a package has been delivered.

7. A method for operating a drone, comprising:
configuring the drone to carry a package;
programming the drone with a location and secure access code of a delivery locker;
flying the drone to the location to find the delivery locker;
utilizing alignment features to align the drone with the delivery locker;
transmitting the secure code from the drone to open a door of the delivery locker;
delivering the package from the drone into the delivery locker through the door; and
transmitting a lock code from the drone to close the door of the delivery locker to secure the package.
